(19) United States
(12) Patent Application Publication
(10) Pub. No.: US 2015/0202833 A1
(43) Pub. Date: Jul. 23, 2015

(54) Machine for Making Sheaths

(71) Applicant: TIDI Products, LLC, Neenah, WI (US)

(72) Inventors: Kurt J. Miller, Neenah, WI (US); Ricky D. Cross, Neenah, WI (US); Vincent E. Portelli, Oshkosh, WI (US); Timothy S. Wolff, Hortonville, WI (US); Brian L. Jochman, Seymour, WI (US)

(21) Appl. No.: 14/601,774

(22) Filed: Jan. 21, 2015

Related U.S. Application Data
(60) Provisional application No. 61/929,876, filed on Jan. 21, 2014.

(51) Int. Cl. B31B 41/00

(52) U.S. Cl. CPC B31B 41/00

(57) ABSTRACT

A machine for making sheaths for use with medical and dental instruments includes a web attachment station for forming a multilayer material by arranging multiple webs of material with respect to one another. A configuration sealing station receives the multilayer material and seals at least two of the multiple webs of material to form a sealed multilayer material including a number of pockets corresponding to the shape of the medical or dental instrument. A material removal station receives the sealed multilayer material and removes an intermediate material, which may be disposed of and recycled at a recycling station.

### CROSS-REFERENCE TO RELATED APPLICATION

The present application claims the benefit of U.S. App. No. 61/929,876 filed Jan. 21, 2014, which is incorporated by reference herein.

### BACKGROUND OF THE INVENTION

1. Field of the Invention

The invention generally relates to machines for making a sheath for use with medical or dental instruments.

2. Discussion of the Related Art

Machines for making sheaths for use with, e.g., medical or dental instruments are well known. Some of these machines make a single type of sheath and typically require multiple passes through the machine to produce sheaths on substrate sheets that have webs of intermediate material between adjacent sheaths on each substrate sheet.

### SUMMARY OF THE INVENTION

The present invention provides a machine configured for rapidly changing machine configuration to produce different sheaths for medical or dental instruments with different pocket shapes and/or other differences in configuration during different production runs. Each production run makes the respective sheaths in a single pass through the machine. This may facilitate making sheaths to fit different types of medical or dental instruments in an efficient manner, without requiring separate machines and while minimizing machine down-time between the production runs. In accordance with a first aspect of the invention, the machine has sheath-specific dies that are installed in a toolless manner at the machine. The dies may be incorporated as die assemblies that are pre-assembled as this or die bodies mounted to mounting plates that are together toollessly installed into the machine during the product line switchover reconfiguration of the machine. The die assemblies may be held in the machine by electromagnetically retaining the die assemblies in presses and/or by way of toolless hardware such as pins for positional locking the die assemblies in retaining channels of presses at various stations of the machine.

In accordance with another aspect of the invention, the machine includes a burn barrier drive system that automatically and incrementally advances a sheet of burn barrier material with respect to a configuration die at a configuration sealing station. The burn barrier drive system may automatically and incrementally drive the burn barrier material by rotating to unwind or pay out material of a first storage roll that crosses under the configuration die as a sheet in a first travel direction and rotating to wind or receive the material, on a second storage roll. This burn barrier driving may be bi-directional so that when the second storage roll collects a sufficient amount of the burn barrier material, the burn barrier drive system rotates the first and second rolls in the opposite rotational directions. This drives burn barrier material under the configuration die in the opposite travel direction to wind the material back on to the first roll. Incremental advancing and/or bi-directional burn barrier material movement allows for heating elements of the configuration die to engage different portions of the burn barrier material without requiring manual feeding or repetitive contacting of the same location of the material by the heating elements. This reduces a likelihood of burn-through or other over-heating of the burn barrier material.

In accordance with another aspect of the invention, a single-pass machine for making sheaths for medical or dental instruments includes a web attachment station. The web attachment station is configured to form a multiplayer material by arranging multiple webs of material with respect to one another. A configuration sealing station is provided and receives the multilayer material from the web attachment station. The configuration sealing station is configured to seal at least two of the multiple webs of material with respect to one another at multiple locations. In this manner, a number of sealed pockets may be defined by the sealed multilayer material. Each, of the sealed pockets defines a sealed periphery that corresponds to the shape of a medical or dental instrument. A material removal station is provided and receives the sealed multilayer material from the configuration sealing station. The material removing station is configured to remove an intermediate material defined between adjacent sealed pockets of the sealed multilayer material and to thereby define an uncovered pocketed material. Finally, a recycling station receives the intermediate material and is configured to incorporate the intermediate material into a recycled material. The recycling station may provide an on-site collection point for the intermediate material for sending to an off-site recycler.

In at least one embodiment of the invention, the multiple webs of material are incrementally advanced through at least some stations of the machine. In another embodiment of the invention, the multiple webs of material are continuously advanced through at least some of the stations of the machine.

In yet another embodiment of the invention, the material removal station includes a blower arranged to pneumatically remove the intermediate material.

In still another embodiment of the invention, the machine further includes a covering web station configured to receive the uncovered pocketed material. The covering web station is configured to cover the uncovered pocketed material with material to define a cover to pocketed material.

In another embodiment of the invention, the machine further includes an indexing station that receives the covered pocketed material and advances the cover pocketed material away from the covering web station.

In yet another embodiment of the invention, the machine further includes a cutting station configured to receive the covered pocketed material from the indexing station. The cutting station is configured to cut the covered pocketed material into sheets of sheaths so that each sheet includes multiple sheaths that can be separated from the remainder of the sheaths of the sheet.

According to another aspect of the invention, multiple dies may be used at the configuration sealing station at different times for making different sheaths. The dies have different patterns that correspond to different pocket shapes of different sets of sheaths to be made during different sessions of the machine. A first die may be arranged at the configuration sealing station for moving toward the multilayer material to create the sealed pockets. The first die may define a first pattern that corresponds to a first pocket shape of a first set of sheaths made during a first session of the machine. A second die may define a second pattern that corresponds to a second pocket shape of a second set of sheaths made during a second session of the machine. The machine may include a controller configured to control the configuration sealing station by adjusting at least one of a heat setting and an engagement time setting to a first setting value when the first die is arranged at the configuration sealing station during a first production run and to a second setting value when the second die is arranged at the configuration sealing station during a second production run.

According to another aspect of the invention, each of the dies includes an electrical connector that allows for toolless connections of the dies to a power source. This may allow for quick changeover between different dies at the configuration sealing station. Each of the dies may include heating wires that are indented with a punch having a lower end with an annular sidewall that includes a slot at one side to align over the heating wire(s) so that the opposite side of the lower end of the punch forms the indentation into the wire. This may allow for dies that are wired in a manner in which the wire fits into the die pattern the same each time, even when built by different individual die builders.

According to another aspect of the invention, the machine has a web attachment station for forming a multilayer material, by arranging multiple webs of material with respect to each other. A configuration sealing station receives the multilayer material from the web attachment station and seals at least two of the multiple webs of material with respect to each other at multiple locations to define a sealed multilayer material having multiple sealed pockets. Each of the sealed pockets defines a sealed periphery corresponding to a shape of a medical or dental instrument. A first configuration die is selectively arranged at the configuration sealing station for moving toward the multilayer material to create the sealed pockets and defining a first pattern, that corresponds to a first pocket shape of a first set of sheaths made during a first session of the machine. A second configuration die is selectively arranged at the configuration sealing station for moving toward the multilayer material to create the sealed pockets and defining a second pattern that corresponds to a second pocket shape of a second set of sheaths made during a second session of the machine. A controller is configured to control the configuration sealing station by adjusting at least one of a heat setting and an engagement time setting to a first setting value when the first configuration die is arranged at the configuration sealing station and to a second setting value when the second configuration die is arranged at the configuration sealing station.

According to another aspect of the invention, a configuration press may be arranged at the configuration sealing station. The configuration press is actuatable to apply pressure between multilayer material and the respective one of the first and second configuration dies. This creates the multiple sealed pockets. Each of the first and second configuration dies is removably mounted to the configuration press with a toolless mounting system.

According to another aspect of the invention, the toolless mounting system may include an electromagnetic retainer arranged at the configuration press. The electromagnetic retainer is configured to selectively secure the configuration die(s) to the configuration press. An electromagnet of the electromagnetic retainer may receive its power from an electrical circuit that is separate from an electrical circuit delivering machine power for operating other components of the machine.

According to another aspect of the invention, the configuration press may include a fixed base block and a moveable press block overlying the fixed base block. The electromagnetic retainer may be arranged to magnetically secure the configuration die(s) to the moveable press block, such as from above to electromagnetically pull and hold the configuration die(s) upwardly against the movable press block in a fixed position.

According to another aspect of the invention, the configuration die may be of multiple component construction that can be preassembled to facilitate relatively quick die changeover events. The configuration die may include a die body with a heating element for creating the multiple sealed pockets and a mounting plate to which the die body attaches, allowing the mounting plate and the body to be mounted as a preassembled unit to the configuration press.

According to another aspect of the invention, the toolless mounting system includes alignment pins and alignment holes defining an alignment interface between the configuration press of the configuration sealing station and each configuration die. The alignment holes receive the alignment pins to locate the configuration die(s) when the die(s) achieves a predetermined aligned position relative to the configuration press. The alignment pins and alignment holes may be arranged at respective upwardly and downwardly facing surfaces of the configuration die(s) and movable press block.

According to another aspect of the invention, the machine includes a die cutting station downstream of and receiving a web of interconnected sheaths defined by the multilayer material with the multiple sealed pockets from the configuration sealing station. The die cutting station may include a cutting press actuatable to apply pressure to the web of interconnected sheaths to separate into relatively smaller segments with relatively fewer interconnected sheaths. A first cutting die may be selectively arranged at the die cutting station for moving toward the interconnected sheaths during actuation of the cutting press. The first cutting die is configured to separate the interconnected sheaths into relatively smaller segments according to a first pattern of separation, such as during a first production run. A second cutting die may be selectively arranged at the die cutting station for moving toward the interconnected sheaths during actuation of the cutting press. The second cutting die is configured to separate the interconnected sheaths into relatively smaller segments according to a second pattern of separation, such as during a second production run. Each of the first and second cutting dies may be removably mounted to the cutting press with a toolless mounting system.

According to another aspect of the invention, the toolless mounting system may include at least one channel in the cutting press that slidingly receives the cutting die(s). The toolless mounting system may include a locking pin configured to extend and retract relative to the cutting press to selectively engage and lock into a locking hole of each of the cutting dies. The locking pin includes a pin body, and a spring that biases the pin body to extend from the cutting press into the locking hole of respective cutting die(s).

According to another aspect of the invention, the cutting die may include a die body with a cutting element for separating the interconnected sheaths and a mounting plate to which the die body attaches, allowing the mounting plate and die body to be mounted as a preassembled unit to the cutting press.

According to another aspect of the invention, a burn barrier defined by a web of heat-resistant material is arranged between the first or second configuration die and the multilayer material to prevent contact of the first or second configuration die and the multilayer material. The burn barrier incrementally advances between cycles during which the pockets are formed, such as between pressing cycles of the configuration die. At least one stepper motor may incrementally advance the burn barrier heat-resistant material with respect to the configuration die(s). A pair of electronic sensors may be arranged to detect a full roll of a pair of rolls of the burn bather heat-resistant material. The stepper motor(s) is reversed and the roll of heat-resistant material is advanced in the opposite direction upon detection of the full roll of the burn barrier heat-resistant material. A one-way clutch may be arranged at a roll of the web of heat-resistant material of the burn barrier to incrementally rotate the roll for advancing the web of heat-resistant material with respect to the configuration sealing station.

According to another aspect of the invention, the machine has a web attachment station for forming a multilayer material by arranging multiple webs of material with respect to each other. A configuration sealing station receives the multilayer material from the web attachment station. The configuration sealing station includes a configuration die that seals at least two of the multiple webs of material with respect to each other at multiple locations to define a sealed multilayer material having multiple sealed pockets during sealing events. Each of the sealed pockets defines a sealed periphery corresponding to a shape of a medical or dental instrument. The configuration sealing station may include a burn barrier arranged between the multilayer material and the configuration die preventing direct contact between the multilayer material and the configuration die. The burn barrier may include a web of heat-resistant material and a burn bather drive. The burn barrier drive may incrementally advance the web of heat-resistant material with respect to the configuration die during time periods between the sealing events. The machine may include an indexing station configured to receive a web of interconnected sheaths defined by the sealed multilayer material with its formed pockets either directly from the configuration sealing station or from an intermediary station such as a covering web station that adds a covering material such as packaging over the sealed and pocketed multilayer material. The indexing station is configured to move a predetermined length of the interconnected sheaths a predetermined distance through the indexing station based on final dimensions of the particular sheaths being made during a production run and/or dimensions of an array of cutting elements of a cutting die. This may be done by way of reciprocating clamps, movable tracks, linear or other motors, or other actuators to advance the interconnected sheaths through the indexing station. The indexing station may receive the interconnected sheaths from a covering web station that applies a covering material which may be packaging-type material over the interconnected sheaths. A die cutting station may receive the covered pocketed material from the indexing station and cut the covered pocketed material into sheets of sheaths so that each sheet includes multiple sheaths that can be separated from the remainder of the sheaths of the sheet.

According to another aspect of the invention, a burn barrier system arranged at the configuration sealing station includes a pair of rolls storing the burn barrier heat-resistant material with the web extending between the pair of rolls. When the burn barrier heat-resistant material advances with respect to the configuration die, burn barrier heat-resistant material is unrolled from one of the rolls and received and rolled onto the other roll. The burn barrier system may include a pair of electronic sensors configured to detect a full roll of the heat-resistant material and a stepper motor. The stepper motor is controlled by a control system to advance the roll of heat resistant material, such as by incremental advancement. When the electronic sensors detect a full roll of the heat resistant material, a direction of the motor is reversed and the roll of heat-resistant material is advanced in the opposite direction.

Another aspect of the invention comprehends a method of making sheaths for use with a medical or dental instrument in a single pass through a machine. The method includes beginning a first production run. During the first production run, multiple webs of material are directed to a web attachment station and a first multilayer material is formed by converging the multiple webs of material onto one another in a first stacked web defining the multilayer material. The first multilayer material is directed to a configuration sealing station. At the configuration sealing station, the first multilayer material is sequentially pressed with a first configuration die sealing the multiple webs of material of the first multilayer material with respect to each other at multiple locations to define a first sealed multilayer material having multiple sealed pockets. This happens during sequential sealing events. Each of the sealed pockets defines a sealed periphery of a first shape corresponding to a shape of a first medical or dental instrument. A burn harrier defined by a web of heat-resistant material is advanced between the first configuration die and the first multilayer material by incrementally moving the heat-resistant material between the sequential sealing events. A second configuration die is prepared by attaching a die body of the second configuration die to a mounting plate. This can be done as a preliminary preparation while the first production run is underway. The first production run can be stopped and the first configuration die may be removed from the configuration sealing station, such as by removing from a press, in a toolless manner. The second configuration die may be toollessly mounted at the configuration sealing station of the machine, such as by mounting to a press in a toolless manner. A second production run begins. During the second production run, multiple webs of material are directed to the web attachment. A second multilayer material is formed by converging the multiple webs of material onto one another in a second stacked web defining the multilayer material. The second multilayer material is directed to the configuration sealing station. At the configuration sealing station, the second multilayer material is sequentially pressed with the second configuration die. This seals the multiple webs of material of the second multilayer material with respect to each other at multiple locations to define a second sealed multilayer material having multiple sealed pockets during sequential sealing events. Each of the sealed pockets defines a sealed periphery of a second shape corresponding to a shape of a second medical or dental instrument. The burn barrier heat-resistant material is advanced between the second configuration die and the second multilayer material by incrementally moving the heat-resistant material between the sequential sealing events.

Various other features, embodiments, and alternatives of the present invention will be made apparent from the following detailed description taken together with the drawings. It should be understood, however, that the detailed description and specific examples, while indicating preferred embodiments of the invention, are given by way of illustration and not limitation. Many changes and modifications could be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout and in which:

FIG. 1 is a schematic diagram of a single-pass machine for making sheaths for medical or dental instruments according to the present invention;

FIGS. 2A-E are schematic representations of various materials at different stages of a session;

FIG. 3 is a pictorial view of a portion of the machine;

FIG. 4 is a front elevation view of a portion of the machine;

FIG. 5 is a schematic view of a die of the machine;

FIG. 6 is a pictorial view of a punch used in making a die;

FIG. 7 is a schematic view of a punch used in making a die;

FIG. 8 is a representation of a matrix used in controlling the machine;

FIG. 9 is a front elevation view of dies being stored;

FIG. 10 is a pictorial view of a portion of the machine;

FIG. 11 is a pictorial view of a portion of the machine;

FIG. 11A is a pictorial view of a portion of the machine;

FIG. 12 is a pictorial view of a magnet for use with a die;

FIG. 13 is a pictorial view of a portion of the machine;

FIG. 14 is a pictorial view of a portion of the machine;

FIG. 15 is a pictorial view of a portion of the machine; and

FIG. 16 is a top plan view of a box for packaging sheaths;

FIG. 17 is a simplified schematic representation of a front elevation of a configuration sealing station;

FIG. 18 is a simplified schematic representation of a cross-sectional view of a portion of the configuration sealing station of FIG. 17;

FIG. 19 is a simplified schematic representation of a front elevation of a die cutting station; and

FIG. 20 is a simplified schematic representation of a cross-sectional view of a portion of the die cutting station of FIG. 19.

### DETAILED DESCRIPTION OF THE PREFERRED EMBODIMENTS

### 1. System Overview

A machine for making sheaths for dental or medical instruments in a single pass utilizes webs of material such as, e.g., polyethylene and/or other polymeric materials. The sheaths are used as cross-contamination barriers and generally consist of a polyethylene sheath packaged between a paper backing web and a plastic or paper-covering web. Additional components may be incorporated into the sheath design as necessary.

The raw materials for forming the sheaths are loaded on one end of the machine and are automatically fed through the machine in a start/stop manner to carry out the necessary operations for forming the sheaths. Understandably, the raw materials may alternatively be fed through in a continuous manner to form the sheaths. The machine operates on a fixed start/stop cycle, and a width of the sheath runs along the length of the machine while the length of the sheath runs along the width. The size and number of sheaths produced may be adjusted by varying the cutting of the web material.

The machine includes a series of stations, such as a web attachment station, a configuration sealing station, a material removal station, an indexing station, a die cutting station, and a recycling station. The web attachment station is configured to form a multilayer material arranged from multiple webs of material with respect to one another. After the material passes through the web attachment station, it is advanced to the configuration sealing station wherein at least two of the multiple webs of material are sealed with respect to each other at any number of locations to thereby define a sealed multilayer material including multiple sealed pockets. Each of the sealed pockets define a sealed periphery that corresponds to a shape of a medical or dental instrument for which the sheath will be used. After passing through the configuration sealing station, the material is advanced to a material removal station wherein the sealed multilayer material has an intermediate material removed therefrom. Intermediate material defined between adjacent sealed pockets of the sealed multilayer material may be removed to define an uncovered pocketed material as a web of interconnected sheaths. After passing to the material removal station, the intermediate material is passed to a recycling station whereby it is incorporated into a recycled material. The web of interconnected sheaths advances to the die cutting station.

### 2. Detailed Description

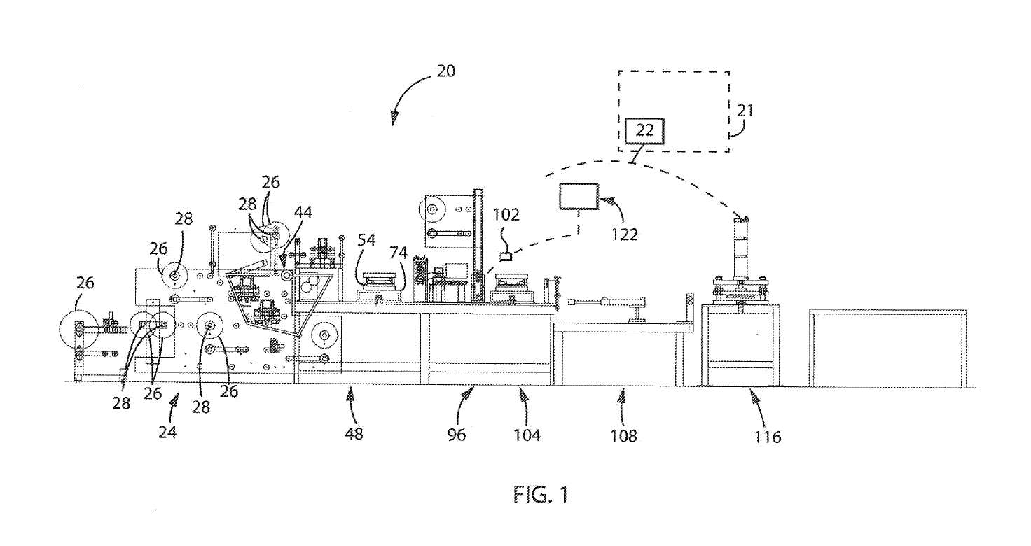

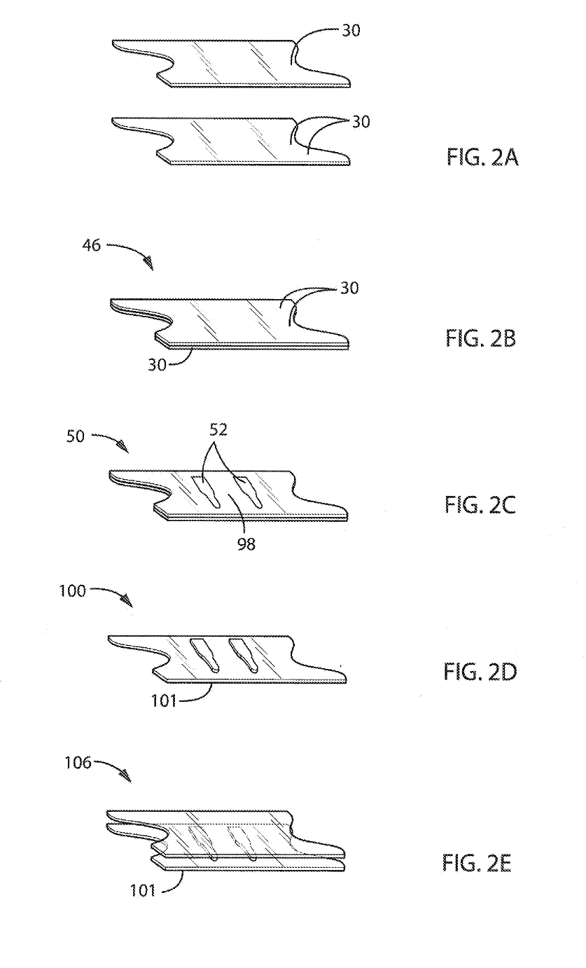

Referring now to FIG. 1, a schematic representation of a machine 20 according to the present invention is provided. The machine 20 includes a control system 21 having a controller 22 that may include an industrial computer or, e.g., a programmable logic controller (PLC), along with corresponding software and suitable memory for storing such software and hardware including interconnecting conductors for power and signal transmission to the various components at the stations of the machine 20 for controlling corresponding operations. The machine 20 includes a web attachment station 24. The web attachment station 24 includes a plurality of rolls 26 of web material that are configured for joining to one another as will be described herein. The rolls 26 may be in the form of polyethylene or any other suitable material. The rolls 26 are supported on shafts 28 driven by the machine 20 and configured to advance the webs of material 30 (FIG. 2A) of the rolls 26 along a length of the machine 20. In particular, the lengths of the web material from rolls 26 are configured to be attached to one another by unwinding of the rolls 26 and positioning of the multiple webs of material with respect to one another such that the web material may be sealed rotative to one another as will be described.

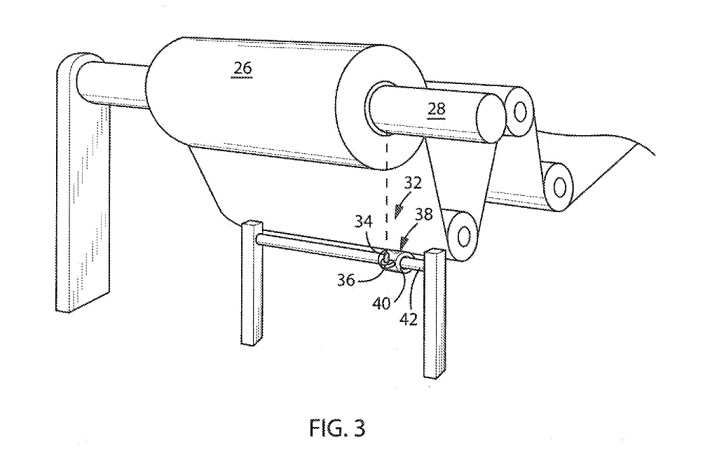

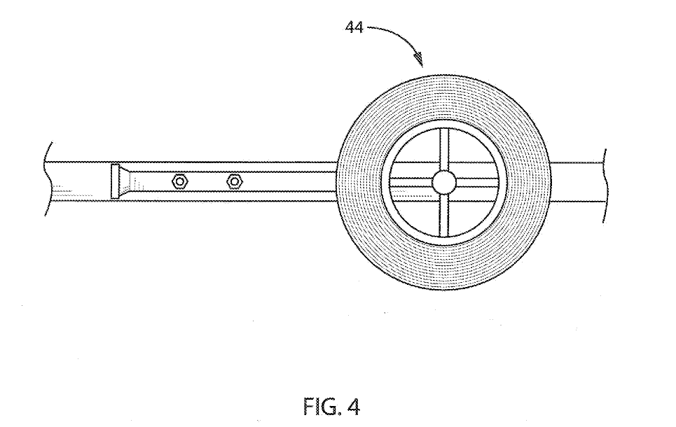

Referring now to FIG. 3, a light indicator 32 may be arranged to provide visual indicia of proper position of each roll 26 relative to the respective shaft 28. The light indicator 32 may include a laser 34 supported by an arm 36 that is attached to a mount 38 that is connected to the machine 20. In this embodiment, the mount 38 is shown as including a collar 40 that concentrically engages a bar 42 of the machine. This may facilitate quick setup of the roll 26 on the shaft 28 and allow anyone to check if roll 26 is positioned in the proper location to reduce roll adjustment time and reduce scrap. During material changeovers between rolls 26, splices can be marked using tape from a tape dispenser 44 arranged on the machine 20, as shown in FIG. 4, to provide a quick visual reference of splice locations. Referring now to FIGS. 1 and 2A-2C, after the multiple webs of material 30 are arranged to form a multilayer material 46 from the aligned rolls 26, the multilayer material 46 is advanced to a configuration sealing station 48. The configuration sealing station 48 is configured to seal the multiple webs of material 30 with respect to one another at a number of locations. In this manner, a sealed multilayer material 50 (FIG. 2C) is defined. The sealed multilayer material 50 may include a plurality of sealed pockets 52. Each of the sealed pockets 52 define a sealed periphery that corresponds to the shape of a medical or dental instrument for which the sheath constructed by the machine 20 is configured for.

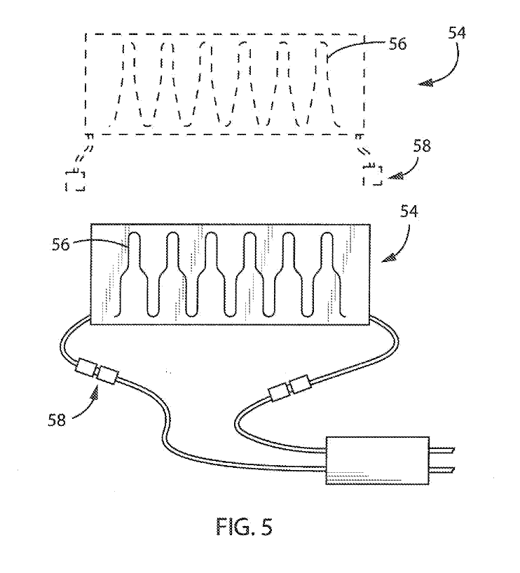

Referring now to FIGS. 1 and 5, different dies shown as configuration dies 54 may be used at the configuration sealing station 48 (FIG. 1) during different sessions for making different sheaths. The configuration dies 54 have different patterns defined by wires 56 that are heated when electrically energized. The different patterns of the wires 56 correspond to different pocket shapes of different sets of sheaths to be made during the different sessions of the machine. A first configuration die 54 may be arranged at the configuration sealing station 48 for moving toward the multilayer material to create the sealed pockets 52 (FIG. 2C) in a press-like manner. The first configuration die 54, represented as the solid-line configuration die 54, may define a first pattern that corresponds to a first pocket shape of a first set of sheaths made during a first session of the machine or a first production run. A second configuration die 54, represented as the dashed-line configuration die 54, may define a second pattern that corresponds to a second pocket shape of a second set of sheaths made during a second session of the machine or a second production run.

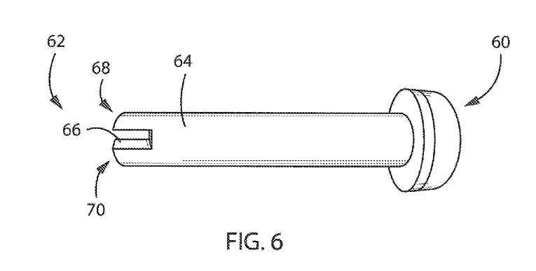

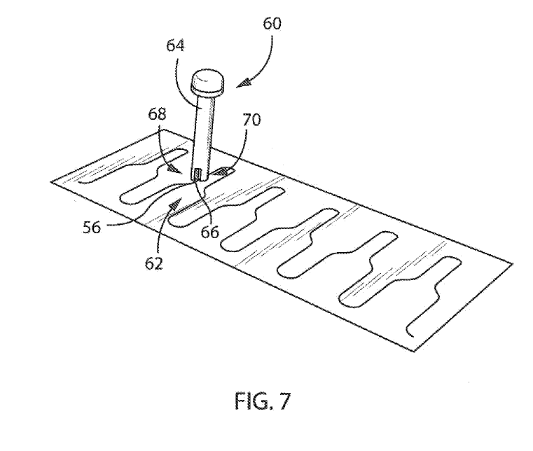

Referring again to FIG. 5, each of the configuration dies 54 includes an electrical connector 58 that allows for toolless connections of the dies to a power source. This may allow for quick changeover between different dies 54 at the configuration sealing station 48. Referring now to FIGS. 5-7, each of the dies 54 may include heating wires 56 that are indented with a punch 60 (FIGS. 6-7) having a lower end 62 with an annular sidewall 64 that includes a slot 66 at one side 68 to align over the heating wire(s) 56 so that the opposite side 70 of the lower end 62 of the punch forms the indentation into the wire 56. This may allow for dies 54 that are wired in a manner in which the wire fits into the die pattern the same each time, even when built by different individuals as die builders.

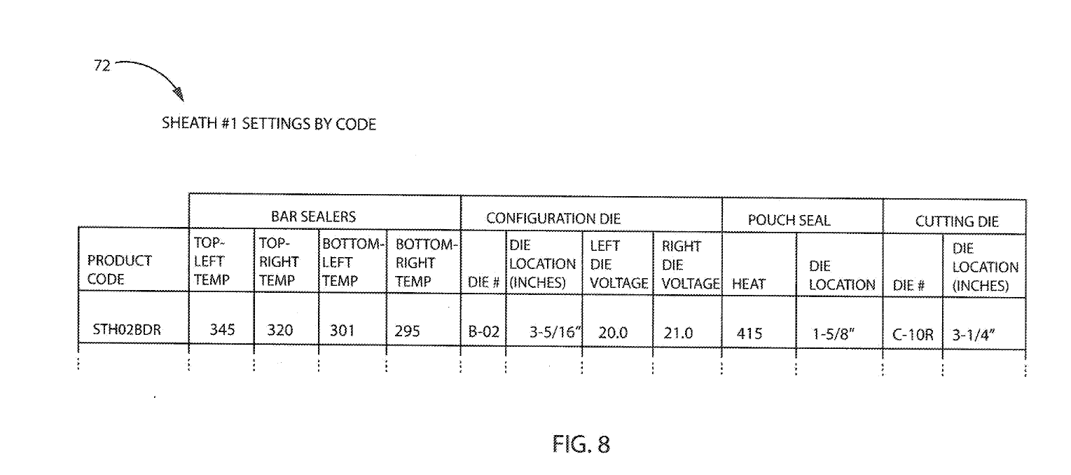

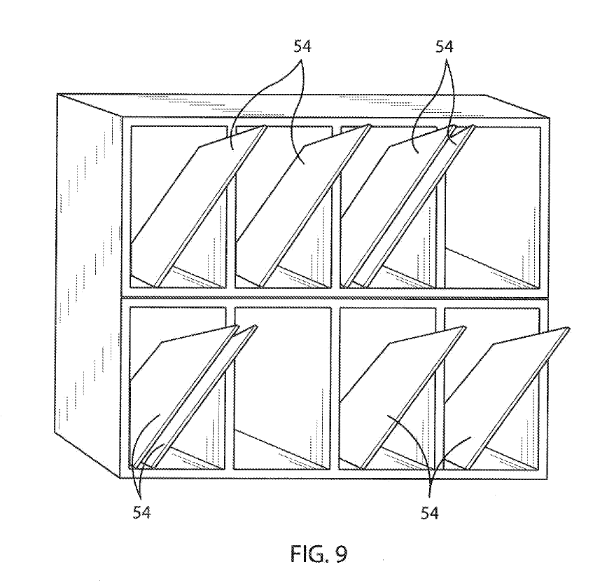

Referring again to FIGS. 1 and 5, the controller 22 (FIG. 1) is configured to control the configuration sealing station 48 by adjusting at least one of a heat setting and an engagement time or press duration setting to a first setting value(s) when the first die 54 is arranged at the configuration sealing station 48 and to a second setting value (s) when the second die 54 is arranged at the configuration sealing station 48. The controller 22 may make such adjustments according to a matrix of recorded settings for the different dies 54, visually represented as an exemplary matrix 72 of recorded settings as shown in FIG. 8. As shown in FIG. 9, the different dies 54 may be stored at another location between uses in the configuration sealing station 48 as separated or in batches that are sorted and tracked by type and use-condition for monitoring use-life and scheduling resurfacing procedures for the dies 54.

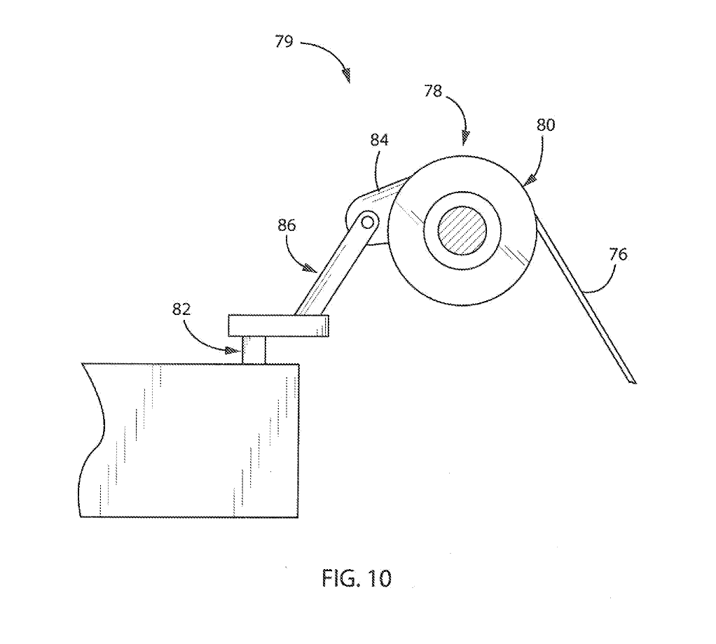

Referring now to FIGS. 1 and 10-11, at the configuration sealing station 48, a burn barrier 74 may be defined by a web of heat-resistant material 76 and arranged between the die 54 and the multilayer material 46 (FIG. 2B) to prevent contact of the die 54 and the multilayer material 46. In a preferred construction of the configuration sealing station 48, Teflon or a similar material is provided as heat-resistant material 76 of the burn barrier 74. The heat-resistant material 76 is stored on a roll 78 and arranged to present a segment of the heat-resistant material 76 between the die 54 and the multilayer material 46 and is advanced automatically after every cycle. A one-way clutch 80, such as a ratchet clutch mechanism, may be arranged with respect to the roll 78 of the heat-resistant material 76 to incrementally rotate the roll 78 for advancing the web of heat-resistant material 76 relative to the configuration sealing station 48 by way of a burn barrier drive system 79. The burn barrier drive system 79 includes various cooperating components configured for moving the burn barrier 74 in a controlled matter to automatically and incrementally advance the burn harrier 74. The burn barrier drive system 79 shown in FIG. 10 includes an actuator 82 that is arranged to move an arm 84 extending from the one-way clutch by way of a link 86 in reciprocation for incrementally rotating the roll 78. This allows for mounting and actuating the one-way clutch 80 to automatically advance the roll 78 of heat-resistant material 76 a predetermined amount in each machine cycle. Because the die 54 only touches the heat-resistant material 46 once per cycle, the roll 78 of heat-resistant material 76 is able to be run through multiple times and no operator is required to advance the heat-resistant material by hand, which may reduce burn through and quality issues, such as leaking.

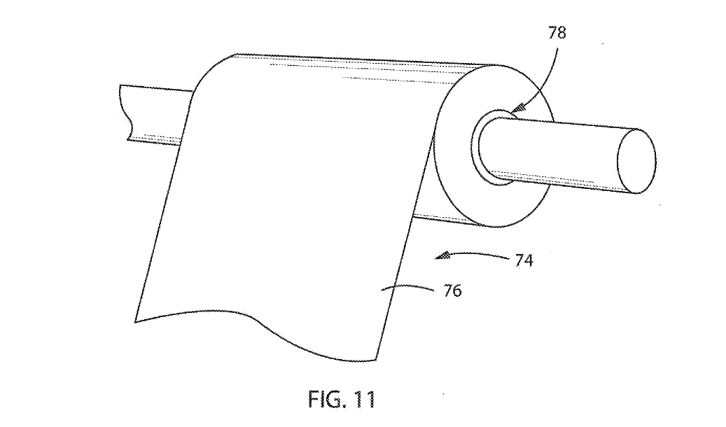

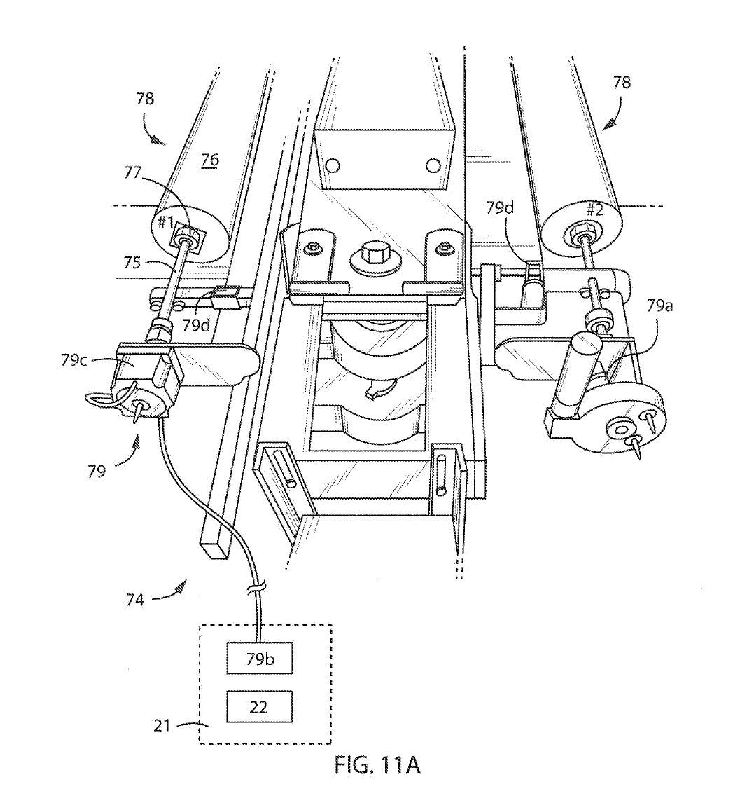

Turning now to FIG. 11A, in another construction of the burn barrier 74, a roll 78 of a heat-resistant material 76 such as Teflon is provided on a cardboard core. The system includes two driven shafts 75 that accept the burn barrier cores. Each core is coupled to the shaft through a coupling 77 such as one of a variety of suitable couplings available from Lovejoy, Inc. The burn barrier drive system 79 shown in FIG. 11A includes a mechanical, air drive-brake 79A is provided on the feed side. The barrier material is fed from the full roll under the configuration die 54 (FIG. 1) to an empty core on the opposite side. The operator then pulls the material tight under the die by turning the pickup core. At this point, the system is prepared for operation. An electronic stepper motor drive 79B of the control system 21 operates the stepper motor 79C needed for direction of material wind up. The burn barrier drive system 79 includes two electronic sensors 79D, schematically represented in FIG. 11A, on either side that sense a full roll. When a full winding roll is sensed, the burn barrier drive system 79 automatically reverses and repeats. Logic controls are provided by the main machine logic controller as controller 22 of the control system 21.

Regardless of the particular configuration of the burn barrier drive system 79, it can be configured to automatically and incrementally drive the burn barrier material or heat-resistant material 76 by rotating to unwind or pay out material of a first storage roll 78 that crosses under the configuration die 54 (FIG. 1) as a sheet in a first travel direction and rotating to wind or receive the material on a second storage roll 78. This burn barrier 74 driving may be bi-directional so that when the second storage roll 78 is full or otherwise collects a sufficient amount of the heat-resistant material 76, the burn barrier drive system 79 rotates the first and second rolls 78 in the opposite rotational directions relative to their previous rotation directions. This drives the heat-resistant material 76 under the configuration die 54 (FIG. 1) in the opposite travel direction to wind the heat-resistant material 76 back on to the first roll 78.

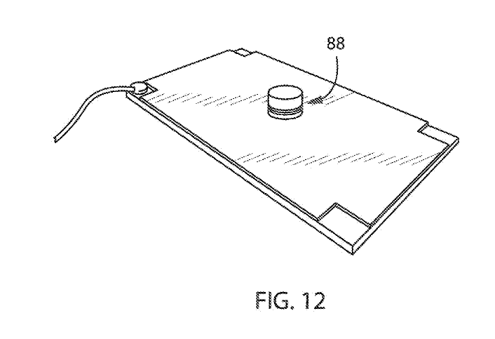

Referring now to FIGS. 1 and 12, the die 54 of the configuration sealing station 48 may be selectively held in a retracted position by a retainer that may include a magnet. FIG. 12 shows a mechanical magnet 88 that may be used to hold the die 54 in place while no electrical power is being provided to the configuration sealing station 48. Referring now to FIGS. 1 and 2A-D, next, the web of the sealed multilayer material 50 is advanced to a material removal station 96. The material removal station 96 receives the sealed multilayer material 50 and removes an intermediate material 98 defined between adjacent sealed pockets 52 of the sealed multilayer material 50 to define an uncovered pocketed material 100, as shown in FIG. 2D. The material removal station 96 may include a blower 102 arranged to pneumatically remove the intermediate material 98 (FIG. 2C). A paper or backer layer 101 may be provided on the pocketed material 100 and covered pocketed material 106.

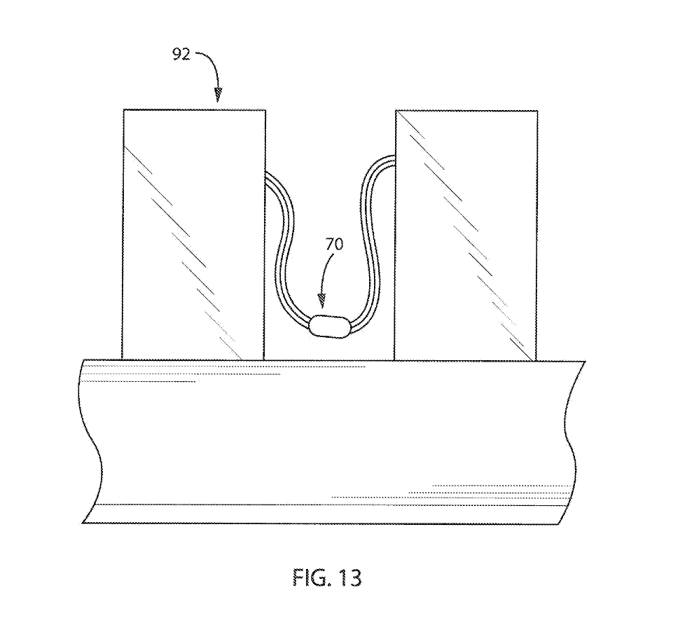

Still referring to FIGS. 1 and 2A-D, after the removal of the intermediate material 98, the uncovered pocketed material 100 is advanced to a covering web station 104 (FIG. 1) at which a cover material is applied to define a covered pocketed material 106 (FIG. 2E). Referring now to FIGS. 1 and 13, in this embodiment, the covering web station 104 includes a pigtail 90 arranged in the conductors between a heat controller 92 of the covering web station 104 and a die, such as a pouch seal die. This allows a thermocouple 94 arranged at the pigtail 90 to be left in the pouch seal die, for example, a conductive lead, and the other segment of the thermocouple connector may be left plugged into the heat controller 92 to thereby eliminate the need for an operator to perform additional steps during changeover. The cover material applied at the covering web station 104 can be a paper material that is incorporated into the end product, such as integral covering or packaging of the product formed during the single pass through the machine 20, so that the covered pocketed material 106 defines a paper top web product. In such implementation, the burn barrier heat-resistant material 76 can be the paper material itself, whereby the web of paper running on top of the product defines the burn barrier 74.

Referring now to FIGS. 1 and 2E, the covered pocketed material 106 (FIG. 2E) is advanced to an indexing station 108 pulls the web of material through the indexing station 108 and all of the upstream stations and portions of the machine 20. The indexing station 108 is configured to move a predetermined length of the interconnected sheaths of the covered pocketed material 106 a predetermined distance through the indexing station 108 based on final dimensions of the particular sheaths being made during a production run and/or other production criteria. For example, the covered pocketed material 106 may be advanced between about 8-12 includes at a time through the indexing station 108. This may be done by way of reciprocating clamps or other hold-down devices and movable tracks, linear or other motors, or other actuators to advance the covered pocketed material 106 through the indexing station 108. The indexing station 108 can be configured to always index the same distance no matter the size of the sheath(s) being made. In such implementation with the same distance indexing, when relatively wider or larger sheaths are being made, relatively fewer sheaths are advanced through the indexing station 108 per indexing stroke or event. When relatively narrower or smaller sheaths are being made, relatively more sheaths are advanced through the indexing station 108 per indexing stroke or event. Also at the indexing station 108, identifying information is applied to the covered pocketed material 106 such as part and lot numbers. This may be done with an ink jet sprayer or the like. The covering material applied at the covering web station 104 is configured to cover the sheath and to keep it clean until it is ready for use. The indexing station 108 is configured to receive the covered pocketed material 106 and to advance the covered pocketed material 106 away from the covering web station 104.

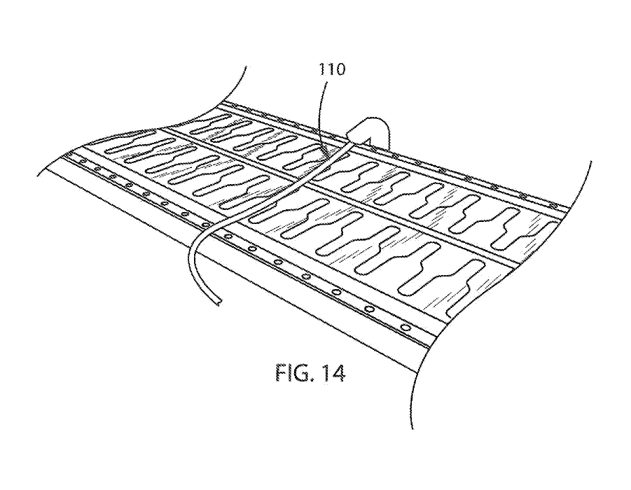

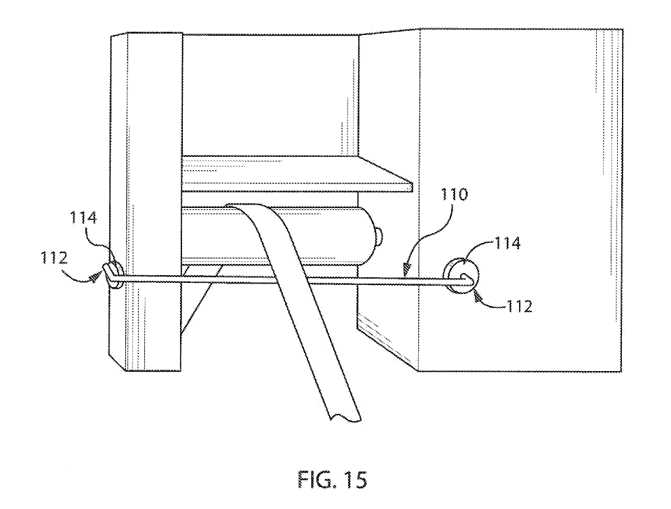

Referring now to FIGS. 1 and 14-15, a static string 110 may be employed to remove static from the product at various locations of the machine 20, for example, after the indexing station 108. The static string 110 may include a non-elastic or elastic cord that extends transversely across the machine 20 and engages the sheaths or material components traveling through the machine 20 to remove static from the product during a session. The static string 110 may be grounded to the machine 20 by a support 112 having a magnetic base 114 removably attached to the machine 20 at each end of the static string 110.

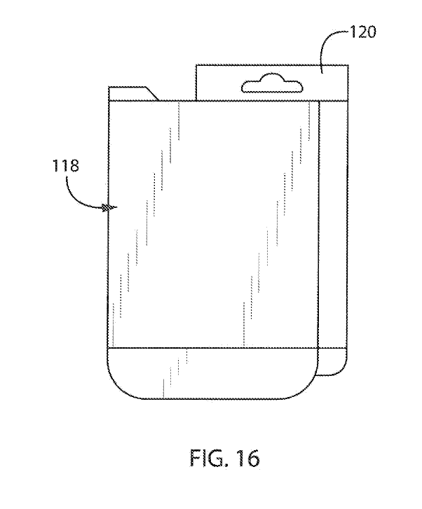

Referring again to FIG. 1, regardless of where the static string(s) may be provided with respect to the machine 20, the web of covered pocketed material 106 may be advanced from the indexing station 108 to a die cutting station 116. The die cutting station 116 is configured to take the web of covered pocketed material 106 and transform it into a sheath(s) or sheet of interconnected sheaths by cutting each sheath(s) from the web. For example, although each sheath is cut from the web of covered pocketed material 106, the sheaths remain attached to one another in index length sheets. At this point, the sheaths are die cut for easy separation for packaging thereof. Testing of the sheaths may be done, for example, by an operator such as a machine operator that performs both an instrument fit test and a water/leak test. Another operator, such as a catcher, may receive the sheaths from the die-cutting station 116 for packaging, which may include inserting the sheaths into boxes 118 with pre-glued hanging tabs 120, such as that shown in FIG. 16. In this way, the sheaths may be formed and packed into boxes as part of a single session that includes a single-pass through the machine 20 rather than as a separate process(es).

Referring again to FIG. 1, a recycling station 122 may be provided and configured to receive the intermediate material that was removed at the material removal station 96. The recycling station 122 may provide an on-site collection point for the intermediate material for sending to an off-site recycler. In another embodiment, the recycling station 122 may be configured to incorporate the intermediate material into a recycled material on-site.

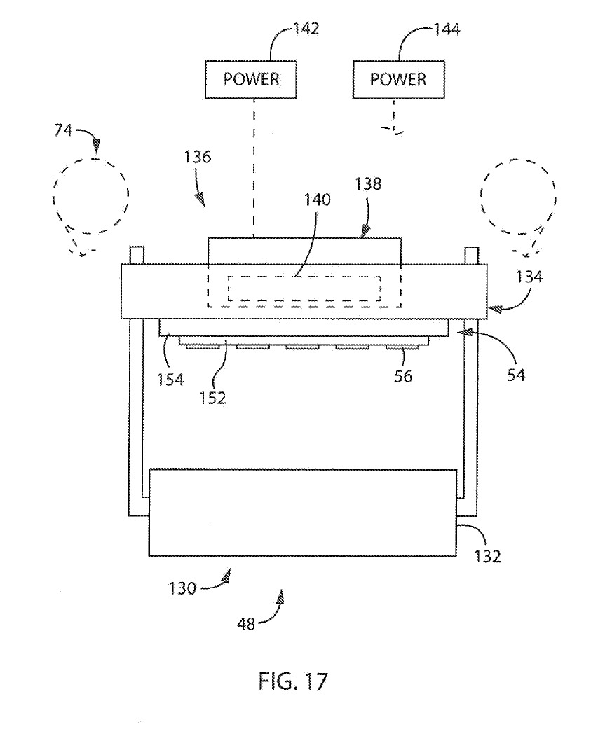

Referring now to the schematic representation of FIGS. 17-20, the machine 20 (FIG. 1) has various sheath-specific dies that are configured along with corresponding machine components for toolless mounting of the dies into the machine 20. As one example and referring now to FIG. 17, the configuration sealing station 48 includes a configuration press 130 that moves the configuration die 54 toward the multilayer material to create the sealed pockets 52 (FIG. 2C) and thus web of interconnected sheaths. Thus the configuration press 130 is actuatable to apply heat and pressure between multilayer material and the configuration die 54 when creating the sealed pockets 52 (FIG. 2C). The configuration press 130 includes a fixed base block 132 and a moveable press block 134 overlying the fixed base block 132, movement of which is controlled by the control system 21 (FIG. 1). A toolless mounting system 136 is configured for mounting each of the configuration dies 54 without requiring tools or manual fastener tightening and loosening by an operator to change the configuration dies 54. Toolless mounting system. 136 as shown in FIG. 17 includes an electromagnetic retainer 138 having an electromagnet 140 arranged to magnetically retained in the dies 54 in the configuration press 130. Electromagnetic retainer 138 is shown arranged at the movable press block 134 with the electromagnetic 140, when energized, electromagnetically pulling and holding the configuration die 54 upwardly against and in a fixed position with respect to the movable press block 134. Electromagnetic retainer 138 receives its electrical power to selectively energize or deenergize the electromagnet 140 from an electrical circuit defining a retainer power electrical circuit 142. Retainer power electrical circuit 142 can be separate from electrical circuit defining a machine main power electrical circuit 144 that provides electrical power for other operations of the machine 20 (FIG. 1), such as main power for moving material through the machine 20, energizing heat demerits, and/or actuating various components of the machine 20.

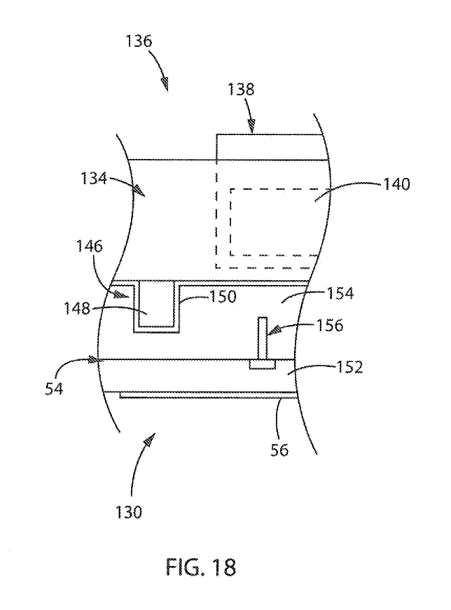

Referring to FIG. 18, toolless mounting system 136 includes an alignment system 146. Alignment system 146 has alignment pins 148 and alignment holes 150 defining an alignment interface between the configuration press 130 of the configuration sealing station 48 and each configuration die 54. Alignment pins 148 are shown extending downwardly from a downwardly facing surface of the moveable press block 134. Alignment holes 150 are shown extending into an upwardly facing surface of the configuration die 54 that abuts the downwardly facing surface of the movable press block 134 the configuration die 54 is mounted in the configuration press 130. It is understood that the alignment pins 148 may instead be provided on the configuration die 54 and the alignment holes 150 may be instead provided on the configuration press 130. The alignment system 146 facilitates maintaining a desired position of the configuration die 54 within the configuration press 130 while an operator energizes the electromagnetic retainer 138 to toollessly lock the configuration die 54 into the configuration press 130.

Still referring to FIG. 18, the configuration die 54 may be of multiple component construction that can be preassembled to facilitate relatively quick die 54 changeover events. The configuration die 54 is shown with a die body 152 to which the heating element or wire 56 is attached. The die body 152 is connected to a mounting plate 154 such as by way of fasteners 156 or otherwise connected. This allows the mounting plate 154 and die body 152 to be mounted as a preassembled unit into the configuration press 130.

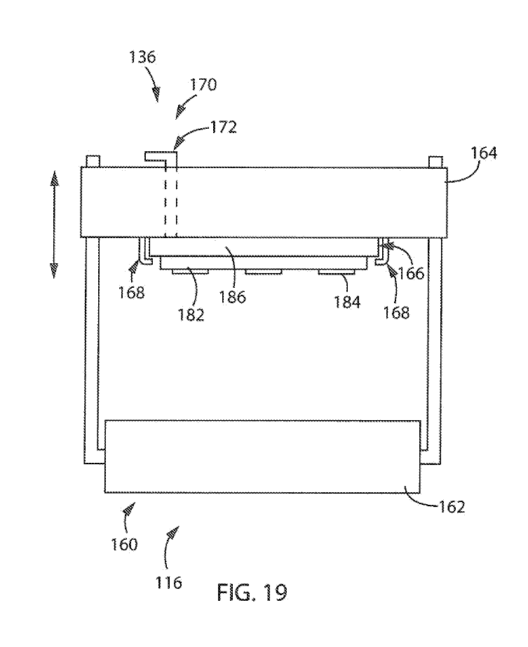

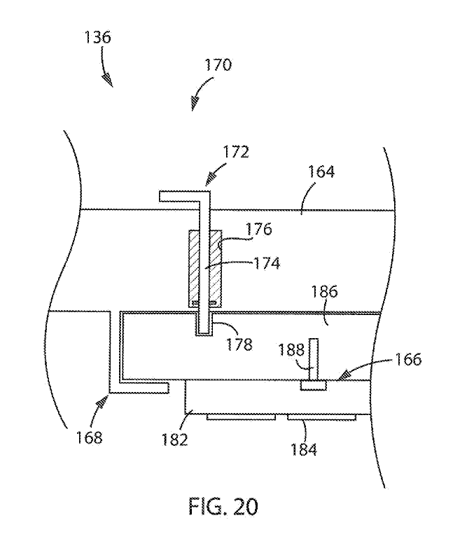

Referring now to FIG. 19, the die cutting station 116 includes a cutting press 160 that is actuatable to apply pressure to the web of interconnected sheaths to separate into relatively smaller segments with relatively fewer interconnected sheaths. The cutting press 160 includes a fixed base block 162 and a moveable press block 164 overlying the fixed base block 162, movement of which is controlled by the control system 21 (FIG. 1). Different cutting dies 166 are mounted in the cutting press 160, depending on the particular type of sheets being made during the production runs of the machine 20 (FIG. 1). The cutting dies 166 are configured to separate the interconnected sheaths into relatively smaller segments according to patterns of separation that correspond to the configuration of the interconnected sheaths been separated at the die cutting station 116 for the respective production run(s). Like the mounting of configuration dies 54 in the configuration press 130 discussed above with respect to FIGS. 17-18, the cutting dies 166 can be toollessly mounted into the cutting press 160 by way of toolless mounting system 136. Whereas the toolless mounting system 136 of FIGS. 17-18 was described as being electromagnetic, the toolless mounting system 136 of FIGS. 19-20 is shown as being mechanical.

Referring now to FIGS. 19-20 toolless mounting system 136 includes a channel 168 at the cutting press 160 that slidingly receives the cutting dies 166. Channel 168 is shown as arranged at the movable press block 164 to receive and support the cutting die 166 and outer portions of the cutting die 166. Toolless mounting system 136 is shown with a locking system 170 having a locking pin 172 configured to extend and retract relative to the cutting die 166 for locking the cutting die 166 in the channel 160. The locking pin 172 includes a pin body 174 and a spring 176 that biases the pin body 174 into a locking hole 178 extending into the cutting die 166. Like multiple component construction of configuration dies 54 discussed above with respect to FIGS. 17-18, the cutting dies 166 can be of multiple component construction that can be preassembled to facilitate relatively quick die 166 changeover events. The cutting die 166 is shown with a die body 182 to which a cutting element 184 such as knife or matrix of spaced apart blades is attached. The die body 182 is connected to a mounting plate 186 such as by way of fasteners 188 or otherwise connected. This allows the mounting plate 186 and die body 182 to be mounted as a preassembled unit into the cutting press 160.

Although the toolless mounting system 136 was described as electromagnetic in the configuration press 130 and mechanical in the cutting press 160, it is understood that the toolless mounting system 136 may instead be mechanical in the configuration press 130 and electromagnetic in the cutting press 160, both may be electromagnetic, or both may be mechanical.

Although the best mode contemplated by the inventors of carrying out the present invention is disclosed above, practice of the present invention is not limited thereto. It will be manifest that various additions, modifications, and rearrangements of the aspects and features of the present invention may be made in addition to those described above without deviating from the spirit and scope of the underlying inventive concept. The scope of some of these changes is discussed above. The scope of other changes to the described embodiments that fall within the present invention but that are not specifically discussed above will become apparent from the appended claims and other attachments.

We claim:

1. A machine for making sheaths for use with a medical or dental instrument in a single pass through the machine, the machine comprising:
a web attachment station for forming a multilayer material by arranging multiple webs of material with respect to each other;
a configuration sealing station receiving the multilayer material from the web attachment station and sealing at least two of the multiple webs of material with respect to each other at multiple locations to define a sealed multilayer material having multiple sealed pockets, each of the sealed pockets defining a sealed periphery corresponding to a shape of a medical or dental instrument;
a first configuration die selectively arranged at the configuration sealing station for moving toward the multilayer material to create the sealed pockets and defining a first pattern that corresponds to a first pocket shape of a first set of sheaths made during a first session of the machine;
a second configuration die selectively arranged at the configuration sealing station for moving toward the multilayer material to create the sealed pockets and defining a second pattern that corresponds to a second pocket shape of a second set of sheaths made during a second session of the machine; and
a controller configured to control the configuration sealing station by adjusting at least one of a heat setting and an engagement time setting to a first setting value when the first configuration die is arranged at the configuration sealing station and to a second setting value when the second configuration die is arranged at the configuration sealing station.

2. The machine of claim 1 further comprising a configuration press at the configuration sealing station, wherein the configuration press is actuatable to apply pressure between multilayer material and the respective one of the first and second configuration dies to create the multiple sealed pockets and wherein each of the first and second configuration dies is removably mounted to the configuration press with a toolless mounting system.

3. The machine of claim 2 wherein the toolless mounting system includes an electromagnetic retainer arranged at the configuration press to selectively secure the respective one of the first and second configuration dies to the configuration press in a fixed position during the corresponding one of the first and second sessions of the machine.

4. The machine of claim 3 wherein the machine receives electrical power for at least one of moving the multiple webs of material through the machine and reciprocating the configuration press from a first electrical circuit defining a machine main power electrical circuit and the electromagnetic retainer receives electrical power for energizing an electromagnet of the electromagnetic retainer from a second electrical circuit defining a retainer power electrical circuit to secure the respective one of the first and second configuration dies to the configuration press in a fixed position.

5. The machine of claim 4 wherein the toolless mounting system further comprises alignment pins and alignment holes defining an alignment interface between the configuration press of the configuration sealing station and each of the first and second configuration dies, wherein the alignment holes receive the alignment pins when the respective one of the first and second configuration dies achieves a predetermined aligned position relative to the configuration press.

6. The machine of claim 4 wherein the configuration press includes a fixed base block and a moveable press block overlying the fixed base block, wherein the electromagnetic retainer is arranged to magnetically secure the first and second configuration dies to the moveable press block, and wherein the alignment pins and alignment holes are arranged at respective upwardly and downwardly facing surfaces of the first and second configuration dies and movable press block.

7. The machine of claim 2 wherein the configuration die includes a die body with a heating element mounted to the die body for creating the multiple scaled pockets and a mounting plate attached to the die body such that the mounting plate and die body of the configuration die are removably mounted as a unit defining the configuration die to the configuration press.

8. The machine of claim 1 further comprising:
a die cutting station downstream of and receiving a web of interconnected sheaths defined by the multilayer material with the multiple sealed pockets from the configuration sealing station, the die cutting station including a cutting press actuatable to apply pressure to the web of interconnected sheaths to separate into relatively smaller segments with relatively fewer interconnected sheaths,
a first cutting die selectively arranged at the die cutting station for moving toward the interconnected sheaths during actuation of the cutting press and configured to separate the interconnected sheaths into relatively smaller segments according to a first pattern of separation;
a second cutting die selectively arranged at the die cutting station for moving toward the interconnected sheaths during actuation of the cutting press and configured to separate the interconnected sheaths into relatively smaller segments according to a second pattern of separation; and
wherein the respective one of the first and second cutting dies is removably mounted to the cutting press with a toolless mounting system.

9. The machine of claim 8 wherein the toolless mounting system includes at least one channel in the cutting press slidingly receiving the respective one of the first and second cutting dies.

10. The machine of claim 9 wherein the toolless mounting system includes a locking pin configured to extend and retract relative to the cutting press to selectively engage and lock into a locking hole of the respective one of the first and second cutting dies.

11. The machine of claim 10 wherein the locking pin includes a pin body, and a spring biasing the pin body to extend from the cutting press into the locking hole of respective one of the first and second cutting dies.

12. The machine of claim 8 wherein the cutting die includes a die body with a cutting element mounted to the die body for separating the interconnected sheaths and a mounting plate attached to the die body such that the mounting plate and die body of the cutting die are removably mounted as a unit defining the cutting die to the cutting press.

13. The machine of claim 1, further comprising a burn barrier defined by a web of paper material converging onto the multilayer material while traveling through the machine and preventing contact of the first or second configuration die and the multilayer material at the configuration sealing station and defining a paper covering to the multilayer material downstream of the configuration sealing station.

14. The machine of claim 1, further comprising a burn barrier defined by a web of heat-resistant material that is arranged between the first or second configuration die and the multilayer material to prevent contact of the first or second configuration die and the multilayer material, the burn barrier incrementally advancing between cycles of the first or second configuration die during which the pockets are formed.

15. The machine of claim 14, further comprising at least one stepper motor incrementally advancing the burn barrier heat-resistant material with respect to the first or second configuration die.

16. The machine of claim 15, further comprising a pair of electronic sensors configured to detect a full roll of the burn barrier heat-resistant material and wherein the at least one stepper motor is reversed and the roll of heat-resistant material is advanced in the opposite direction upon detection of the full roll of the burn barrier heat-resistant material.

17. The machine of claim 14, further comprising a one-way clutch arranged at a roll of the web of heat-resistant material of the burn barrier to incrementally rotate the roll for advancing the web of heat-resistant material with respect to the configuration sealing station.

18. A machine for making sheaths for use with a medical or dental instrument in a single pass through the machine, the machine comprising:
a web attachment station for forming a multilayer material by arranging multiple webs of material with respect to each other;
a configuration sealing station receiving the multilayer material from the web attachment station and including a configuration die sealing at least two of the multiple webs of material with respect to each other at multiple locations to define a sealed multilayer material having multiple sealed pockets during sealing events, each of the sealed pockets defining a sealed periphery corresponding to a shape of a medical or dental instrument, the configuration sealing station including a burn barrier arranged between the multilayer material and the configuration die preventing direct contact between the multilayer material and the configuration die, wherein the burn barrier includes a web of heat-resistant material and a burn barrier drive configured to incrementally advance the web of heat-resistant material with respect to the configuration die between the sealing events.

19. The machine of claim 18, further comprising a pair of rolls storing the burn harrier heat-resistant material with the web extending between the pair of roils so that while the burn barrier heat-resistant material advances with respect to the configuration die, burn barrier heat-resistant material is unrolled from one of the rolls of the pair of rolls and rolled onto the other one of the rolls of the pair of rolls.

20. The machine of claim 19, further comprising a pair of electronic sensors configured to detect a full roll of the heat-resistant material and a stepper motor configured to advance the roll of heat resistant material, wherein when the electronic sensors detect a full roll of the heat resistant material, a direction of the motor is reversed and the roll of heat-resistant material is advanced in the opposite direction.

21. A method of making sheaths for use with a medical or dental instrument in a single pass through a machine, the method comprising:
beginning a first production run and during the first production run,
directing multiple webs of material to a web attachment station and forming a first multilayer material by converging the multiple webs of material onto one another in a first stacked web defining the multilayer material;
directing the first multilayer material to a configuration sealing station and at the configuration sealing station sequentially pressing the first multilayer material with a first configuration die sealing the multiple webs of material of the first multilayer material with respect to each other at multiple locations to define a first sealed multilayer material having multiple sealed pockets during sequential sealing events, each of the scaled pockets defining a sealed periphery of a first shape corresponding to a shape of a first medical or dental instrument;
advancing a burn barrier defined by a web of heat-resistant material between the first configuration die and the first multilayer material by incrementally advancing the heat-resistant material between the sequential sealing events;
preparing a second configuration die by attaching a die body of the second configuration die to a mounting plate of the second configuration die;
stopping the first production run;
toollessly removing the first configuration die from the configuration sealing station of the machine;
toollessly mounting the second configuration die to the configuration sealing station of the machine;
beginning a second production run and during the second production run,
directing multiple webs of material to the web attachment station and forming a second multilayer material by converging the multiple webs of material onto one another in a second stacked web defining the multilayer material;
directing the second multilayer material to the configuration sealing station and at the configuration sealing station sequentially pressing the second multilayer material with the second configuration die sealing the multiple webs of material of the second multilayer material with respect to each other at multiple locations to define a second sealed multilayer material having multiple sealed pockets during sequential sealing events, each of the sealed pockets defining a sealed periphery of a second shape corresponding to a shape of a second medical or dental instrument;
advancing the burn barrier heat-resistant material between the second configuration die and the second multilayer material by incrementally advancing the heat-resistant material between the sequential sealing events.
